(19) United States
(12) Patent Application Publication
(10) Pub. No.: US 2008/0011319 A1
(43) Pub. Date: Jan. 17, 2008

(54) Cosmetic Sampler and Process to Manufacture the Same

(75) Inventor: Pablo Eugenio Ripoli, Barueri - Sp (BR)

Correspondence Address: DARBY & DARBY P.C., P.O. BOX 770, Church Street Station, New York, NY, 10008-0770, US

(73) Assignee: Pablo Eugenio Ripoli, Barueri - Sp (BR)

(21) Appl. No.: 10/572,260

(22) PCT Filed: Sep. 22, 2004
(86) PCT No.: PCT/BR04/00180

§ 371 Date: Mar. 28, 2007

(30) Foreign Application Priority Data
Sep. 25, 2003 (BR) PI 0303884-0

(51) Int. Cl. A45D 40/00; B32B 37/00; B65D 69/00

(52) U.S. Cl. 132/286; 156/297; 206/581

(57) ABSTRACT

COSMETIC SAMPLER AND PROCESS TO MANUFACTURE THE SAME, said cosmetic sampler comprising: a base film (10) presenting an oleophobic upper face (11); a cosmetic product portion (20) deposited an retained on the oleophobic upper face (11) of the base film (10); a covering film (30) having an oleophobic lower face (32) hermetically and removably fixed onto the oleophobic upper face (11) of the base film (10), in order to cover the cosmetic product portion (20). The process to manufacture the cosmetic sampler comprises the steps of: depositing on said oleophobic upper face (11) of the base film (10) a cosmetic product portion (20) maintained at a determined temperature range and according to a predetermined contour, and removably fixing the covering film (30) against said oleophobic upper face (11) of the base film (10), in order to retain said cosmetic product portion (20) according to said previously determined contour.

### FIELD OF THE INVENTION

The present invention refers to a cosmetic sampler, particularly a sampler of a cosmetic of the type that comprises a base substrate, generally in the form of a plastic film, upon which is seated an individual portion of a cosmetic to be covered with a generally transparent covering film on the cosmetic portion region.

### BACKGROUND OF THE INVENTION

To promote its products, the cosmetic industry relies on several means, such as: the availability of the product in try-on packages in specialized stores, for instance, department stores; small samples distributed personally or via direct mailing; and small samples inserted in printed media, such as magazines, among others.

In the first case, there is the inconvenience that the product of the same package comes into contact with the skin of indistinct people from the grand public, generating the constant risk of contracting skin diseases and other diseases having the cosmetic as the contamination means.

The personal or direct mailing distribution is limited due to its high costs, considering that it requires a considerable personnel and distribution means structure, and furthermore, due to lacking the verbal promotion of the product, ample promotional literature is required. This marketing means presents the further shortcoming of not permitting an adequate selection of the target consumer for the product.

In view of the above, the cosmetics industry has concluded that one of the preferred means to market its products is through sampling inserts, not only due to permitting the selection of the target consumer for the product by simply choosing the type of publication for its disclosure, but also due to the simplicity with which the inserted sampler is distributed, at a minimal cost.

Within this concept, the state-of-the-art presents several constructive variations discussed hereunder. An example of the solutions defined in the state-of-the-art are defined in Brazilian Patent Application No. PI 9913811 (Color Prelude) directed to a cosmetic sampler construction and a method to manufacture the same, wherein said sampler a covering film, under which an individual dose or portion of the cosmetic is applied, with a protective support sealed onto the covering film.

According to the method defined in the corresponding U.S. patent application Ser. No. 6,190,730, the plastic film is forcefully pre-printed with an opaque copy defining a window visually defining the sample printed on the other face of the film, opposite the window.

In another solution of the state-of-the-art, Brazilian Patent Application No. PI 9901813 (Color Prelude), corresponding to U.S. Pat. No. 6,006,916, a construction of a sampler and its method of manufacture is claimed, wherein said sampler includes an application material. Also in this case the sample is visible through a transparent window provided on the covering film.

U.S. Pat. No. 5,690,130 (Color Prelude) presents a constructive solution that requires the provision of at least one cosmetic applicator integrated to a sustaining base for the cosmetic portion and the provision of a recess (or well) on the base, to contain said sample. Also in this case a transparent window is provided on the covering film.

Further according to the state-of-the-art, U.S. Pat. No. 5,562,112 (Color Prelude) describes a constructive solution for a lipstick sampler that is characterized by the cosmetic portion, as an individual dose, being printed on a base and having, printed thereon, a protective covering to retain the lipstick, a laminated protective film being provided over the base with the aid of an adhesive.

In an attempt to overcome the problems of the above-mentioned solutions, as described hereunder, U.S. Pat. No. 5,647,941 (Color Prelude) claims a method to produce a lipstick sampler including the steps of heating, mixing, cooling, grinding and reapplication differing from the procedures defined in the art.

The above-mentioned known solutions for inserts known in the art present a series of drawbacks and limitations, mainly in their processing: apart from requiring two additional processing steps, already a production cost-enhancing factor, the solvent-extraction step used makes the process even more costly, due to the additional energy consumption.

Another shortcoming, common to the great majority of known samplers, refers to the impossibility of obtaining a decorative layout of the product on the base substrate, requiring therefor the application of an amount of remolten product on the substrate, the decorative theme being defined in a transparent window provided on the covering film applied over the product sample mass. This remelting of the product, further to a certain degree of thermal decomposition, results in an additional energy expense.

### OBJECTS OF THE INVENTION

It is therefore an object of the invention to provide a cosmetic sampler which permits the application, on at least part of its base film, of an amount of a pasty cosmetic product, such as, creams, lipsticks, ointments, glosses, stick or cream deodorants, liquid bases, stick perfumes, and the like, defining in its structure, a suggestive pattern of the application of the product. An interaction generally occurs between the pattern of the product and the pattern printed on the support film, generally in paper and fixable onto the base film.

Another object of the present invention is to provide a process to form said cosmetic product sampler that reduces to a minimum the number of process steps, eliminating the necessity of remelting the product and thus avoiding its thermal decomposition, however permitting the application thereof on the base film according to the desired contour.

### SUMMARY OF THE INVENTION

These and other objects and advantages of the present invention are attained through the provision of a cosmetic sampler, comprising:
a base film presenting an oleophobic upper face;
a cosmetic product portion deposited and retained on the oleophobic upper face of the base film, in a way such as to present a previously determined contour;
a covering film removably secured against the oleophobic upper face of the base film so as to cover the cosmetic product portion, said covering film having an oleophobic lower face and being hermetically welded onto the base film at least along a welding line external and adjacent the contour of the cosmetic product portion.

In another aspect, the present invention comprises a process to manufacture a cosmetic sampler, as defined above, comprising the steps of:
providing a base film presenting an oleophobic upper face;
providing a load of cosmetic product within a supply chamber controlledly heated to maintain the load of cosmetic product molten within a determined temperature range;
positioning the base film, with its oleophobic upper face facing upwards, in communication with a heated printing chamber at a controlled temperature, predetermined and adjustable in view of the cosmetic product being worked;
depositing, through the printing chamber and onto the oleophobic upper face of the base film, a portion of the cosmetic product fed through the supply chamber, said cosmetic product portion being maintained within said predetermined temperature range, while it is being deposited onto the oleophobic upper face of the base film, according to a predetermined contour and smaller than that of the base film;
removing the base film, with the cosmetic product portion from the region of the printing chamber and promoting the desired degree of drying desired for the cosmetic product; and
fixing, in a removable manner, a covering film having an oleophobic lower face, against the oleophobic upper face of the base film at least along a welding line external and adjacent the contour of the cosmetic product portion, whereby to retain the latter according to said predetermined contour.

It should be understood that the base film can have its lower face, opposite to that of seating and retaining of the cosmetic product portion, fixed, permanently or removably, to a paper, cardboard, light cardboard, couché, polyolefin foam, EVA, PVC foam film, etc., in the form of a magazine page, a leaflet, a carton, etc. decorated or not with messages and themes referring to the presented cosmetic product and which can de visually observed through the transparencies of the base and covering films, when thus constructed.

The problems presented by the prior art are overcome by the present invention, since:
the sample can be printed in any desired shape, the shape of the portion of cosmetic not being defined by the covering film window;
the covering film is transparent and does not have any type of printing;
no substances of any are added to or subtracted from the cosmetic portion to be exposed as a sample, thereby guaranteeing the quality of the exposed product; and
the cosmetic product has its quality preserved since, not having been subjected to the usual remelting step, its thermal decomposition, even partial, is avoided.

Other features and advantages of the present invention shall be further evidenced by the detailed description of the invention and the drawings illustrated hereunder.

### BRIEF DESCRIPTION OF THE DRAWINGS

The invention will be further described based on the attached drawing, wherein:

FIG. 1 represents a partially cut-away top view of a cosmetic sampler constructed according to the present invention;

FIG. 2 represents a magnified side cut-away view of the cosmetic sampler, taken along line II-II of FIG. 1, and further illustrating the base film settled and fixed onto a carton;

FIG. 3 represents a top view of the cosmetic sample of FIGS. 1 and 2, in a partially removed condition of the covering film; and

FIG. 4 represents schematic perspective view of an equipment to carry out the deposition of the cosmetic on the base film.

### DETAILED DESCRIPTION OF THE INVENTION

The present invention refers to a cosmetic sampler destined to retain and expose high viscosity pasty cosmetic products, such as lipsticks, stick perfumes, creams, ointments, stick and creamy deodorants, glosses, liquid bases, and the like.

Samples according to the present invention are useful particularly to be distributed as inserts in printed media, such as magazines, newspapers, and the like, being, however, distributable through other known manners.

In the case of deodorants, further to serving as a sampler of the product, it can be offered as individual use deodorants in hotels, motels, airplanes, academies, etc., and also as reinforcements of peoples' daily hygiene.

According to the invention, a cosmetic sampler 1 comprises: a base film 10, presenting at least one oleophobic upper face 11 and a lower face 12; a cosmetic product portion 20, deposited and retained over said oleophobic upper face 11 of base film 10; and a covering film 30, presenting an oleophobic lower face 32 and being removably fixed onto oleophobic upper face 11 of base film 10, in order to cover cosmetic portion 20.

In the present invention, the basic film 10 is made from a transparent, translucent, or even opaque sheet or film, of a thermoplastic material selected from the group consisting of high density polyethylene, polypropylene, poly(vinyl chloride), PVDC, poly(ethylene terephthalate), polycarbonate, polystyrene, polyesters, co-polyesters and derivatives thereof, and presents a thickness that can vary according to the end use of the sampler. Generally, the thickness of base film 10 varies from about 1 m to 75 m.

In one constructive embodiment, base film 10 is made from a suitably modified thermosealed polyester, such as MYLAR™ OL 50. Since this material is oleophobic, it does not require any additional coating on the oleophobic upper face 11 of base film 10 and can present a thickness from about 12 m to 40 m.

The covering film 30 can be defined by a film of the same constructive material as base film 10, generally transparent, for prompt visualization of the cosmetic product portion 20. However, in certain applications, the material of covering film 30 may be metallized, whereby transparency is eliminated.

The fixation of covering film 30 over base film 10 is carried out along at least one welding line 13 external to and adjacent the contour of cosmetic product portion 20 deposited onto base film 10, in order to maintain the integrity of the contour of said cosmetic product portion 20.

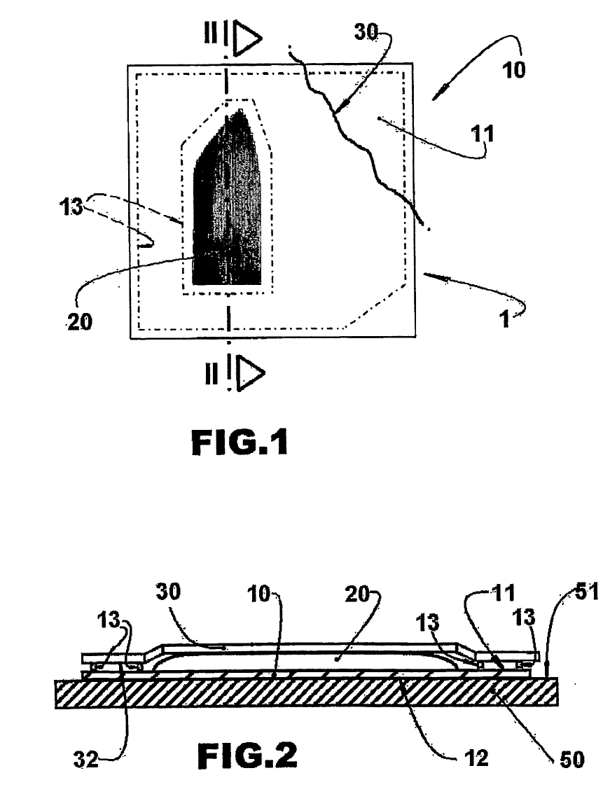

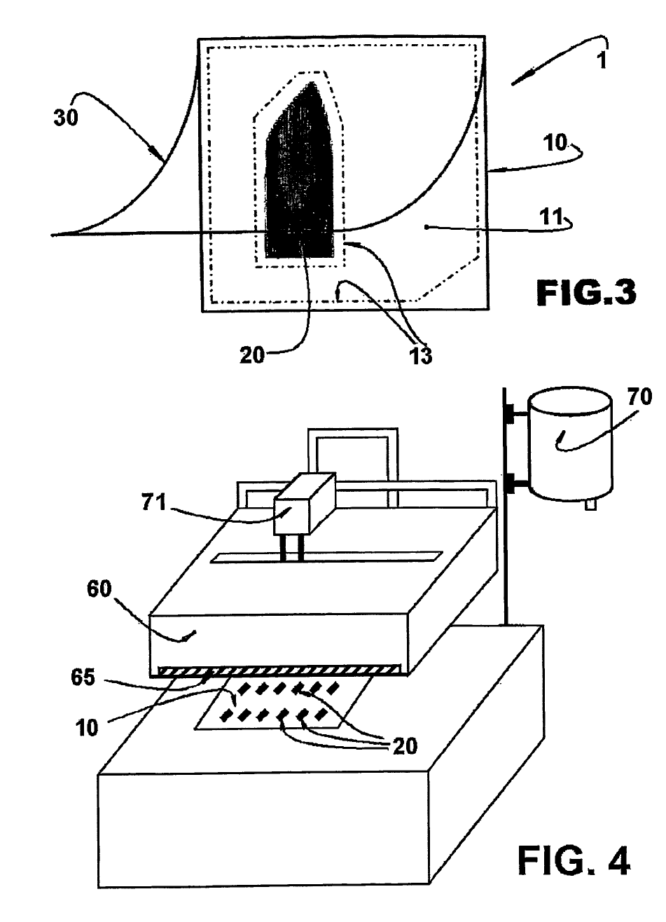

As illustrated in FIGS. 1 and 3, the fixation between base film 10 and covering film 30 can de carried out, additionally, through another welding line 13 extending along the peripheral region of both films. Other dispositions of welding line 13 are possible to attend to particularities of different applications of the sampler.

Welding lines 13 are preferably obtained by the localized hot melting of one film against the other, since these plastic films are constructed such as to permit this type of welding. It should be understood that the welding lines 13 can also be obtained through the localized application of a permanent tag (pressure sensitive) adhesive on at least one of the surfaces defined by the oleophobic upper face 11 of base film 10 and by oleophobic lower face 32 of covering film 30. This case is usable only for perfume samplers which are required for use several times and wherein the product does not decompose, this type of welding being inapplicable in cases like for creams, lipstick, gloss, deodorants, liquid bases, etc.

Another suitable manner to obtain welding lines 13 consists in applying a fusible thermoplastic material, comprising an aluminum barrier film, a polyester, and a sealing resin or polyethylene, on at least one of the surfaces defined by oleophobic upper face 11 of base film 10 and oleophobic lower face 32 of covering film 30.

It is further possible to obtain welding lines 13 through the localized application of high frequency or UV radiation on a junction region of the two films provided with a suitable, easily and rapidly curable adhesive.

Cosmetic product portion 20 is applied onto oleophobic upper face 11 of base film 10, any known printing technique being usable therefor, such as, for instance, screen printing, offset, lithography, flexography, etc. In a preferred embodiment of the invention, cosmetic product portion 20 is applied onto base film 10 through screen printing.

The printing process as defined above is applied directly in case cosmetic product portion 20 is a lipstick, gloss, cream, liquid base, stick perfume. In case it is a stick or cream deodorant, the incorporation of other component elements will depend on the type of product used, in order to verify the need or not of adding any component, such as a solvent, diluent, thickener, silicones, volatiles, etc.

In the preferred application technique, screen printing, a stainless steel screen is used, through which during the application of the paste the desired pattern is already obtained.

In order that the pasty cosmetic product portion can de suitably and safely deposited onto oleophobic upper face 11 of base film 10 with a predetermined contour, a certain procedure different from those used up to the present date is necessary, and which is being described hereunder.

To carry out the instant fabrication process, a load of the pasty cosmetic product is provided within a supply chamber 70, which is controlledly heated, by any known heating means, to maintain the load of cosmetic product molten.

In the case of lipsticks, the internal temperature of supply chamber 70 should be maintained 40° C. and 70° C.

A portion of base film 10 is positioned, with oleophobic upper face 11 turned upwards and in communication with the lower region of a printing chamber 60 provided with a screen printing means 65 and heated to a controlled temperature, within a predetermined temperature range in order that a viscosity suitable for the deposition step is obtained with a controlled definition of the contour of cosmetic product portion 20 to be deposited onto base film 10.

The predetermined temperature is adjustable as a function of the cosmetic product being worked. The temperature of printing chamber 60 should be maintained, in the case of lipstick samplers, in a temperature range from about 45 to 75° C.

Thereafter, the deposition is carried out, through any suitable technique, as for instance through screen printing by means of a printing roll system and collecting spatula 71, over oleophobic upper face 11 of base film 10, positioned under (for screen printing deposition) or within heated printing chamber 60 (for lithographical or flexographical printing), a portion of the cosmetic product portion feeded from supply chamber 70.

The feed from printing chamber 60 shall be by gravityfrom supply chamber 70, according to the amount of product to be deposited, between intervals varying from 20 to 30 minutes in the case of screen printing.

The cosmetic product portion is thus maintained within said predetermined temperature range, while it is deposited onto oleophobic upper face 11 of base film 10, according to a predetermined contour and evidently smaller than that of base film 10.

After the deposition of cosmetic product portion 20 onto base film 10, the latter is removed from the region of printing chamber 60 and subjected to a determined desired degree of drying of the deposited cosmetic product.

After cosmetic product portion 20 having reached the desired degree of drying, a covering film 30 is fixed, removably, against oleophobic upper face 11 of base film 10, said fixation being effected at least along a welding line 13 external and adjacent the contour of cosmetic product portion 20, in order to retain the latter according to said predetermined contour.

As already mentioned previously, the fixation between base film 10 and covering film 30 can be carried out through a plurality of welding lines 13 wherein a peripheral welding line 13 can be interrupted close to a vertex of the cosmetic sample or subjected to an inward deviation, to leave a marginal portion of base film 10 and covering film 30 not fixed to each other, in order to facilitate the catch by the user of an end portion of covering film 30 when removing it from base film 10.

As illustrated in FIG. 2, base film 10 can have its lower face 12, oleophobic or not, and opposed to that of seating and retention of cosmetic product portion 20, fixed, permanently or removably, to upper face 51 of a paper, cardboard, light cardboard, couché, polyolefin foam, EVA, PVC foam film, etc. support film 50, in the form of a magazine page, a leaflet, a carton, etc. with a contour corresponding to that of base film 10 and covering film 30 or any contour larger and that may be decorated with messages and themes referring to the cosmetic product being presented in the sampler. In the case where base film 10 and covering film 30 are produced from transparent material, support film 50 may have a decoration on its upper face, visible through the two transparent films, allowing the association of instructive and decorative messages with the contour to be printed of the cosmetic product portion deposited over base film 10.

It should be understood that the fixation of lower face 12 of base film 10 onto support film 50 can be carried out through different systems, for instance applying adhesive to define a permanent fixation or through the partial hot melting of resins in mutual contact on both parts of the sampler in order to permit, is desired, that the base film and the covering film be removed together from support film 50 and deposited on any other support, such as a magazine page or a promotional catalog sheet. This situation is particularly suitable when the samplers are previously manufactured and delivered to the cosmetic product manufacturer who will take these samplers, remove support film 50, applying the base film 10 and covering film 30 assembly over any promotional support used by said manufacturer.

Although only one constructive form has been illustrated herein for the instant cosmetic sampler, it should be understood that form and layout changes of the different component parts can be effected, without parting from the constructive concept defined in the claims that accompany the present specification.

1. A cosmetic sampler, comprising:
a base film presenting an oleophobic upper face;
a cosmetic product portion heated deposited within a predetermined viscosity and retained in a predetermined contour on the oleophobic upper face of the base film;
a covering film having an oleophobic lower face and being removably secured against the oleophobic upper face of the base film so as to cover the cosmetic product portion, said covering film having an oleophobic lower face and being hermetically welded onto the base film at least along a welding line external and adjacent the contour of the cosmetic product portion.

2. Sampler, according to claim 1, wherein the cosmetic product portion comprises a high viscosity, pasty cosmetic selected from the group consisting of a lipstick, a cream, a stick deodorant, gloss, liquid base, stick perfume, an ointment and the like.

3. Sampler, according to claim 2, wherein the covering film is a transparent material.

4. Sampler, according to claim 3, wherein the base film is made from the same material as the covering film.

5. Sampler, according to claim 4, wherein the base film and the covering film are made from a transparent polyester.

6. Sampler, according to claim 1, wherein the base film is made from a different material from that of the covering film.

7. Sampler, according to claim 1, wherein the base film is transparent or translucent and obtained from a thermoplastic material selected from the group consisting of high density polyethylene, polypropylene, poly (vinyl chloride), PVDC, poly (ethylene terephthalate), polycarbonate, polystyrene, polyesters, co-polyesters and derivatives thereof.

8. Sampler, according to claim 7, wherein the base film is made from a modified thermosealed polyester having a thickness from about 1 μm to 75 μm and, preferably, from about 12 μm to 40 μm.

9. Sampler, according to claim 1, wherein the covering film is fixed onto the base film by means of a welding line defined by a localized application of heat on said base film and covering film.

10. Sampler, according to claim 9, wherein the material of the welding line is selected from an adhesive material and a fusible thermoplastic material.

11. Sampler, according to claim 1, characterized in that the base film has a lower face seated and fixed onto the upper face of a support film.

12. Sampler, according to claim 11, wherein the upper face of the support film contains printings referring to the cosmetic product of the sample.

13. Sampler, according to claim 11, wherein the support film is selected from the materials defined by paper, cardboard, light cardboard, couché, polyolefin foam, EVA, PVC foam.

14. Process to manufacture a cosmetic sampler, comprising the steps of:
providing a base film presenting an oleophobic upper face;
providing a load of cosmetic product within a supply chamber controlledly heated to maintain the load of cosmetic product molten within a determined temperature range;—positioning the base film A, with its oleophobic upper face facing upwards, in communication with a heated printing chamber in which are provided printing means at a controlled temperature, predetermined and adjustable in view of the cosmetic product being worked in order that a viscosity suitable for a deposition step is obtained for said product;
depositing, by means of a printing roll system or a collecting spatula of a screen printing system, and through the printing chamber and onto the oleophobic upper face of the base film, a cosmetic product portion feed through the supply chamber, said cosmetic product portion being maintained within said predetermined temperature range, while it is being deposited onto the oleophobic upper face of the base film in order to maintain said viscosity suitable for deposition in a predetermined contour and smaller than that of the base film;
retaining said cosmetic product portion with said predetermined contour on the oleophobic upper face of the base film;
removing the base film with the cosmetic product portion from the region of the printing chamber and promoting the desired degree of drying for the cosmetic product; and
fixing, in a removable manner, a covering film having an oleophobic lower face against the oleophobic upper face of the base film at least along a welding line external and adjacent the contour of the cosmetic product portion, whereby to retain the latter according to said predetermined contour.

15. Process, according to claim 14, wherein the step of depositing the cosmetic portion is carried out through a printing technique selected from the group consisting of screen printing, lithography, flexography and the like.

16. Process, according to claim 14, wherein the step of fixing comprises producing a welding line through the localized application of heat on the base film and the covering film.

17. Process, according to claim 14, wherein the welding line comprises the application of an adhesive material on at least one of the surfaces defined by the oleophobic upper face of the base film and the oleophobic lower face of the covering film.

18. Process, according to claim 14, wherein the welding line comprises the application of a thermoplastic material on at least one of the surfaces defined by the oleophobic upper face of the base film and the oleophobic lower face of the covering film.

19. Process, according to claim 18, wherein the fusible thermoplastic material comprises a film with an aluminum barrier, polyester and a sealing resin or polyethylene.
